(19) United States
(12) Patent Application Publication
(10) Pub. No.: US 2012/0140159 A1
(43) Pub. Date: Jun. 7, 2012

(54) PIXEL ARRAY SUBSTRATE AND METHOD OF FABRICATING THE SAME

(75) Inventors: Meng-Chi Liou, Taoyuan County (TW); Yuan-Hao Chang, Taipei City (TW)

(73) Assignee: CHUNGHWA PICTURE TUBES, LTD., Taoyuan (TW)

(21) Appl. No.: 13/031,251

(22) Filed: Feb. 21, 2011

(30) Foreign Application Priority Data
Dec. 6, 2010 (TW) 99142396

(51) Int. Cl. G02F 1/1343; B05D 5/06; B05D 3/00; B05D 5/12

(52) U.S. Cl. 349/143; 427/58

(57) ABSTRACT

A pixel array substrate includes a substrate, a plurality of scan lines, a plurality of data lines, a plurality of active devices, a passivation layer, a common electrode, a dielectric layer, and a plurality of pixel electrodes. The substrate has a display area and a peripheral area. The scan lines and the data lines are intersected. The active devices are electrically connected to the scan lines and the data lines. The passivation layer covers the active devices. The common electrode is configured on the passivation layer and located in at least the display area. The dielectric layer covers the common electrode. The pixel electrodes are configured on the dielectric layer. Each of the pixel electrodes is electrically connected to one of the active devices. Each of the pixel electrodes has a plurality of slits. A portion of the common electrode under the slits is not shaded by the pixel electrodes.

### CROSS-REFERENCE TO RELATED APPLICATION

This application claims the priority benefit of Taiwan application serial no. 99142396, filed on Dec. 6, 2010. The entirety of the above-mentioned patent application is hereby incorporated by reference herein and made a part of this specification.

### BACKGROUND OF THE INVENTION

1. Field of the Invention

The invention relates to a pixel array substrate and a method of fabricating the same. More particularly, the invention relates to a pixel array substrate applicable to a display device and a method of fabricating the pixel array substrate.

2. Description of Related Art

Recently, thin film transistor liquid crystal display (TFT-LCD) panels have been developed toward high contrast ratio, no gray scale inversion, high brightness, high color saturation, fast response speed, and wide viewing angle. At this current stage, LCD panels featuring the wide viewing angle include twisted nematic (TN) LCD panels equipped with wide viewing films, in-plane switching (IPS) LCD panels, fringe field switching (FFS) LCD panels, and multi-domain vertical alignment (MVA) LCD panels.

For instance, the FFS LCD panels are characterized by wide viewing angle and low color shift. However, in a conventional FFS LCD panel, the electric field between the pixel electrodes and the common electrode is insufficient, such that the display luminance of the convention FFS LCD panel is not high enough, which reduces the display quality of the FFS LCD panel. Accordingly, how to improve both the display luminance and the display quality of the FFS LCD panel is one of the issues to be resolved by researchers.

### SUMMARY OF THE INVENTION

The invention is directed to a pixel array substrate that can improve the display luminance of a FFS display panel.

The invention is further directed to a display panel that has favorable display aperture ratio and favorable display quality.

The invention is further directed to a method of fabricating a pixel array substrate. By applying this method, the pixel array substrate that improves the transmittance of an FFS display panel can be fabricated.

In an embodiment of the invention, a pixel array substrate includes a substrate, a plurality of scan lines, a plurality of data lines, a plurality of active devices, a passivation layer, a common electrode, a dielectric layer, and a plurality of pixel electrodes. The substrate has a display area and a peripheral area. The peripheral area is substantially connected to the display area. The scan lines and the data lines are configured in the display area of the substrate. The scan lines and the data lines are intersected. The active devices are configured in the display area of the substrate and electrically connected to the scan lines and the data lines. The passivation layer covers the active devices. The common electrode is configured on the passivation layer and located at least in the display area. The dielectric layer covers the common electrode. The pixel electrodes are configured on the dielectric layer, and each of the pixel electrodes is electrically connected to one of the active devices. Each of the pixel electrodes has a plurality of slits, and a portion of the common electrode located under the slits is not shaded by the pixel electrodes.

In an embodiment of the invention, a display panel includes the aforesaid pixel array substrate, an opposite substrate, and a display medium layer. The pixel array substrate is opposite to the opposite substrate, and the display medium layer is configured between the pixel array substrate and the opposite substrate.

In an embodiment of the invention, a method of fabricating a pixel array substrate includes following steps. A substrate on which a plurality of scan lines, a plurality of data lines, a plurality of active devices, and a plurality of common electrode lines are formed is provided. The substrate has a display area and a peripheral area connected thereto. The scan lines and the data lines are intersected. Each of the active devices is electrically connected to a corresponding one of the scan lines and a corresponding one of the data lines. The common electrode lines and the data lines are intersected. A passivation layer is formed, and the passivation layer covers the active devices and the common electrode lines. A plurality of first openings are formed in the passivation layer that is located above the common electrode lines, and the first openings expose the common electrode lines. A common electrode is formed on the passivation layer. The common electrode is located in the display area and fills the first openings, such that the common electrode is electrically connected to the common electrode lines. A dielectric layer is formed on the common electrode. A plurality of second openings are formed in the passivation layer and the dielectric layer that are located above the active devices. The second openings expose the active devices. A plurality of pixel electrodes are formed on the dielectric layer. The pixel electrodes are located in the display area of the substrate, and the second openings corresponding to the pixel electrodes are filled with the corresponding pixel electrodes, such that the pixel electrodes are electrically connected to the corresponding active devices. Here, each of the pixel electrodes has a plurality of slits, and a portion of the common electrode located under the slits is not shaded by the pixel electrodes.

In an embodiment of the invention, a method of fabricating a pixel array substrate includes following steps. A substrate having a display area and a peripheral area is provided. The peripheral area is substantially connected to the display area on which a plurality of scan lines, a plurality of data lines, and a plurality of active devices are formed. The scan lines and the data lines are intersected. Each of the active devices is electrically connected to a corresponding one of the scan lines and a corresponding one of the data lines. The peripheral area of the substrate has a peripheral circuit formed thereon. A passivation layer is formed, and the passivation layer covers the active devices and the peripheral circuit. A third opening is formed in the passivation layer that is located above the peripheral circuit, and the third opening exposes the peripheral circuit. A common electrode is formed on the passivation layer, and the common electrode is located in both the peripheral area and the display area. The third opening is filled with a portion of the common electrode located in the peripheral area, such that the common electrode is electrically connected to the peripheral circuit. A dielectric layer is formed on the common electrode. A plurality of fourth openings are formed in the passivation layer and the dielectric layer that are located above the active devices, and the fourth openings expose the active devices. A plurality of pixel electrodes are formed on the dielectric layer. The fourth openings corresponding to the pixel electrodes are filled with the corresponding pixel electrodes, such that the pixel electrodes are electrically connected to the active devices corresponding thereto. Each of the pixel electrodes has a plurality of slits, and a portion of the common electrode located under the slits is not shaded by the pixel electrodes.

Based on the above, one dielectric layer is sandwiched by the pixel electrodes and the common electrode in a direction perpendicular to the surface of the substrate in the pixel array substrate described in an embodiment of the invention. By contrast, a plurality of insulating layers are sandwiched by the pixel electrodes and the common electrode in the conventional pixel array substrate. Namely, in the pixel array substrate described in an embodiment of the invention, the distance between the pixel electrodes and the common electrode is short, such that the electric field between the pixel electrodes and the common electrode is significant. As such, the display medium in the display panel that has the pixel array substrate can be effectively driven by the display panel, and thereby the transmittance of the display panel can be effectively improved.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1E are schematic top views illustrating a process of fabricating a pixel array substrate according to an embodiment of the invention.

FIG. 2A to FIG. 2E are schematic cross-sectional views taken along a sectional line I-I′ of FIG. 1A to FIG. 1E and illustrating the process of fabricating the pixel array substrate.

FIG. 3A to FIG. 3E are schematic top views illustrating a process of fabricating a pixel array substrate according to another embodiment of the invention.

FIG. 4A to FIG. 4E are schematic cross-sectional views taken along a sectional line II-II′ and a sectional line III-III′ of FIG. 3A to FIG. 3E and illustrating the process of fabricating the pixel array substrate.

FIG. 5 is a schematic cross-sectional view illustrating a display panel according to an embodiment of the invention.

### DESCRIPTION OF EMBODIMENTS

### First Embodiment

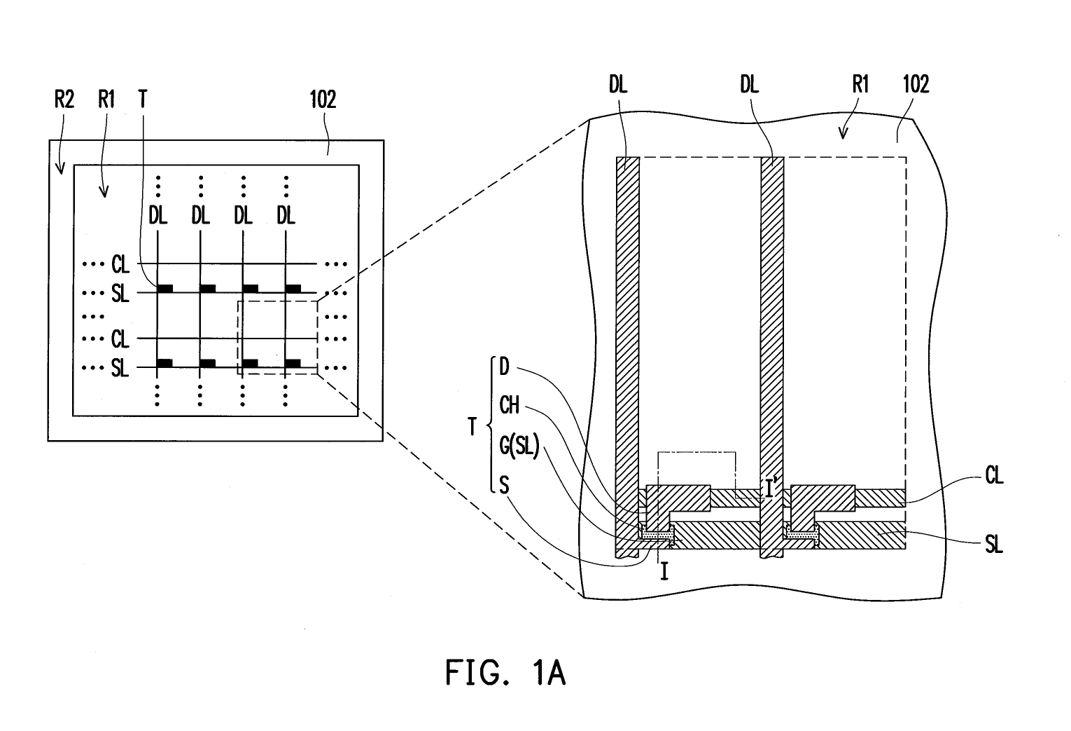

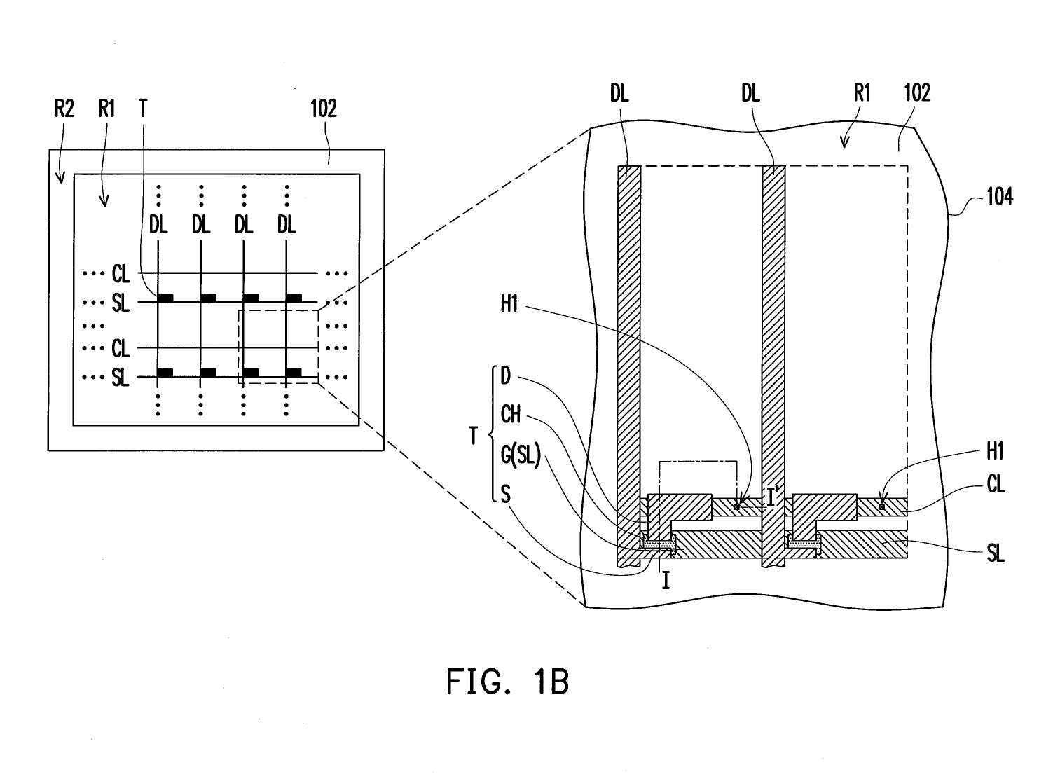

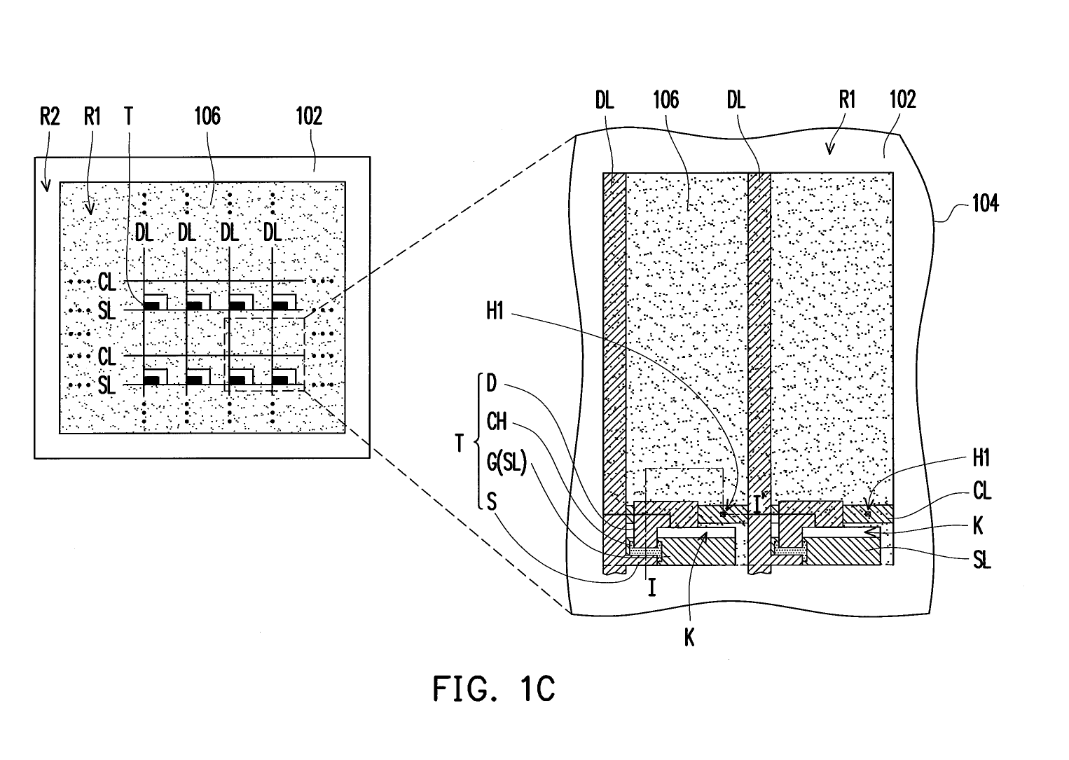

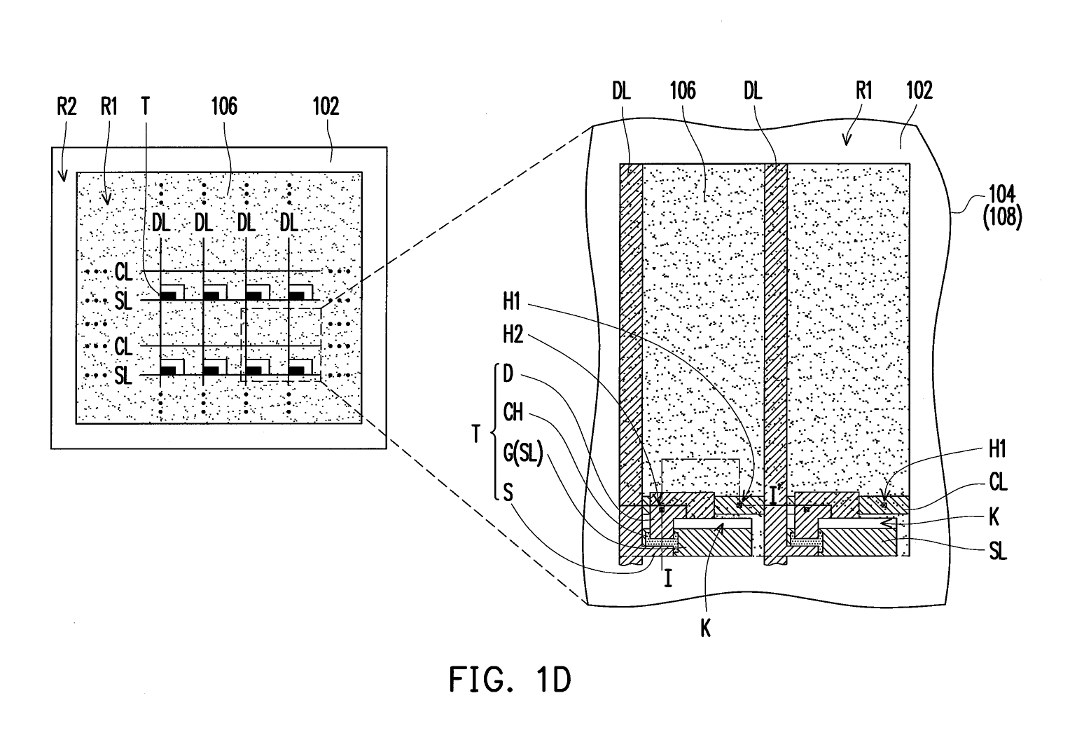

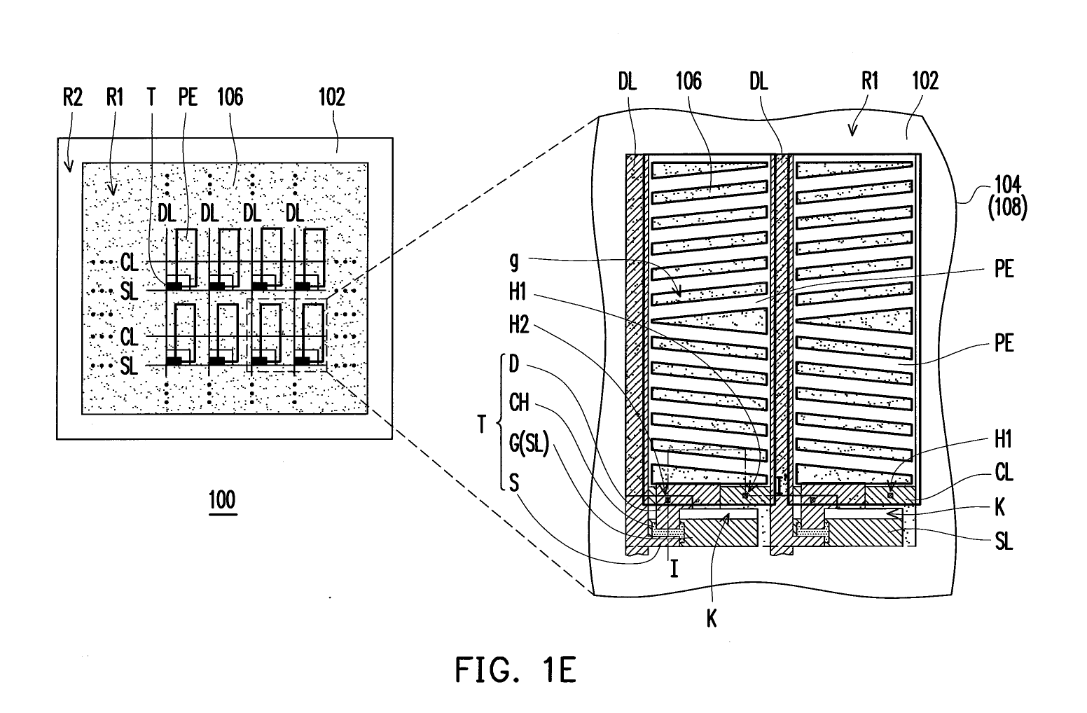

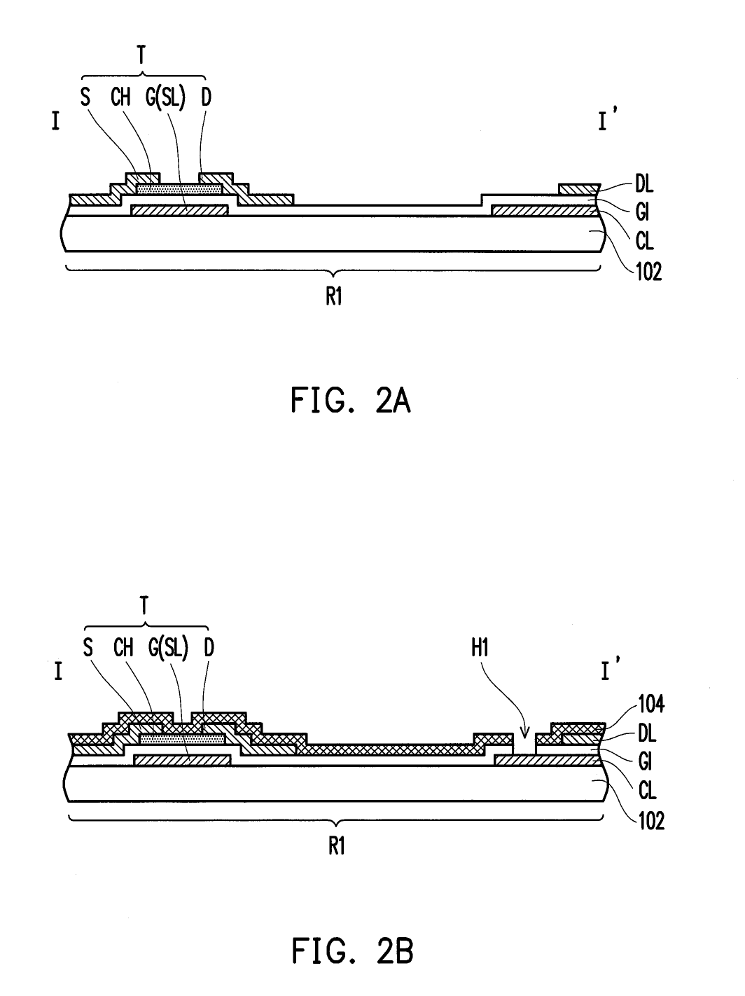

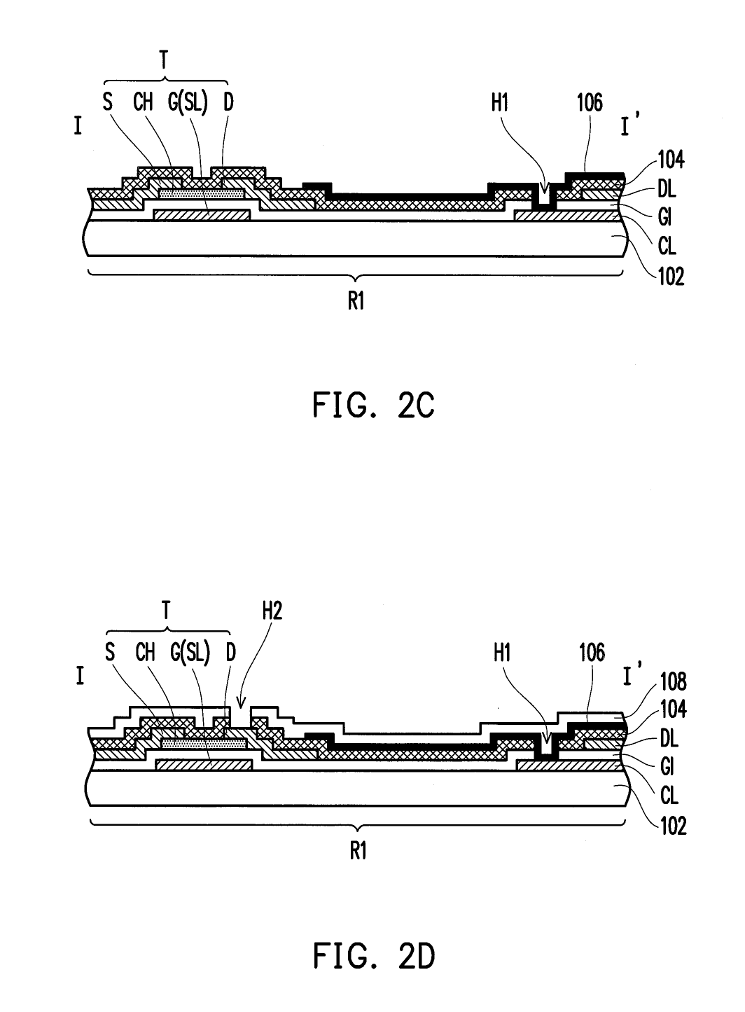

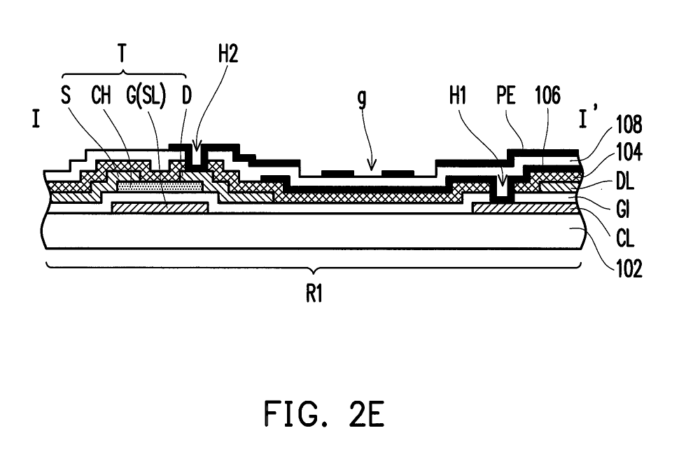

FIG. 1A to FIG. 1E are schematic top views illustrating a process of fabricating a pixel array substrate according to an embodiment of the invention. FIG. 2A to FIG. 2E are schematic cross-sectional views taken along a sectional line I-I′ of FIG. 1A to FIG. 1E and illustrating the process of fabricating the pixel array substrate.

With reference to FIG. 1A and FIG. 2A, a substrate 102 is provided. The substrate 102 has a display area R1 and a peripheral area R2. The peripheral area R2 is substantially connected to the display area R1. For instance, the peripheral area R2 surrounds the display area R1, and the peripheral area R2 is a ring-shaped area connected to the display area R1. However, the invention is not limited thereto. According to other embodiments of the invention, the peripheral area R2 connected to the display area R1 can also be in other shapes. The substrate 102 of this embodiment mainly carries elements and can be made of glass, quartz, organic polymer, or an opaque/reflective material (e.g., a conductive material, a wafer, ceramics, or any other appropriate material), or any other appropriate material.

A plurality of scan lines SL and a plurality of common electrode lines CL are formed on the display area R1 of the substrate 102. According to this embodiment, an extension direction of the common electrode lines CL is substantially parallel to an extension direction of the scan lines SL. In consideration of conductivity, the scan lines SL and the common electrode lines CL are normally made of metal materials. However, the invention is not limited thereto. In other embodiments of the invention, the scan lines SL and the common electrode lines CL can also be made of other conductive materials. For instance, the scan lines SL and the common electrode lines CL can be made of an alloy, metal nitride, metal oxide, metal oxynitride, or a stacked layer containing metal materials and other conductive materials.

An insulating layer GI is formed on the substrate 102, and the insulating layer GI covers the scan lines SL and the common electrode lines CL. The insulating layer GI can be made of an inorganic insulating material (e.g., silicon oxide, silicon nitride, silicon oxynitride, or a stacked layer containing at least two of the aforesaid materials), an organic insulating material, or a combination thereof.

Parts of the scan lines SL serve as gates G, and channel layers CH are formed on the gates G. Data lines DL and drains D are simultaneously formed on the channel layers CH and the insulating layer GI. Here, the data lines DL and the scan lines SL are intersected. Namely, an extension direction of the data lines DL and the extension direction of the scan lines SL are not parallel. Preferably, the extension direction of the data lines DL is perpendicular to the extension direction of the scan lines SL. Additionally, in this embodiment, parts of the data lines DL that are overlapped with the channel layers CH serve as the sources S, and the active devices T are then formed. Namely, the active devices T are electrically connected to the scan lines SL and the data lines DL. The active devices T described above are bottom-gate TFTs, for instance, which should not be construed as a limitation to the invention. In other embodiments, the active devices T can also be top-gate TFTs, multi-gate TFTs, and so on. During fabrication of the scan lines SL, the gates G can be parts of the scan lines SL or formed by an extending portion of the scan lines SL, which should not be construed as a limitation to the invention.

The data lines DL intersect the scan lines SL and the common electrode lines CL. In other words, the extension direction of the data lines DL is not parallel to the extension direction of the scan lines SL and the extension direction of the common electrode lines CL. In an embodiment of the invention, the extension direction of the data lines DL is perpendicular to the extension direction of the scan lines SL and the extension direction of the common electrode lines CL, for instance. A material of the data lines DL is similar to that of the scan lines SL and that of the common electrode lines CL, and thus no further descriptions are provided herein.

With reference to FIG. 1B and FIG. 2B, a passivation layer 104 is formed on the substrate 102, and the passivation layer 104 is a transparent passivation layer, for instance. Besides, the passivation layer 104 covers the active devices T, the common electrode lines CL, the scan lines SL, and the data lines DL. A plurality of first openings H1 are formed in the passivation layer 104 and the insulating layer GI that are located above the common electrode lines CL, and the first openings H1 expose the common electrode lines CL. The passivation layer 104 of this embodiment can be made of an inorganic insulating material (e.g., silicon oxide, silicon nitride, silicon oxynitride, or a stacked layer containing at least two of the aforesaid materials), an organic insulating material, or a combination thereof.

As indicated in FIG. 1C and FIG. 2C, a common electrode 106 is formed on the passivation layer 104. The common electrode 106 is located in the display area R1 and fills the first openings H1, so as to electrically connect the common electrode lines CL. Note that the common electrode 106 of this embodiment has a plurality of openings K that expose a portion of the active devices T and a portion of the scan lines SL electrically connected to the active devices T. As such, the parasitic capacitance between the common electrode 106 and the scan lines SL and between the common electrode 106 and the active devices T can be effectively reduced, and issues of signal delay and large driving load can be resolved. In this embodiment, the common electrode 106 is a transparent conductive layer that includes metal oxide, e.g., indium tin oxide (ITO), indium zinc oxide (IZO), aluminum tin oxide (ATO), aluminum zinc oxide (AZO), indium germanium zinc oxide (IGZO), any other appropriate oxide, or a stacked layer containing at least two of the above materials.

With reference to FIG. 1D and FIG. 2D, a dielectric layer 108 is formed on the substrate 102, and the dielectric layer 108 covers the common electrode 106. The dielectric layer 108 of this embodiment also covers the active devices T, the insulating layer GI, the scan lines SL, and the data lines DL. A plurality of second openings H2 are formed in the passivation layer 104 and the dielectric layer 108 that are located above the active devices T, so as to expose the drains D of the active devices T. The dielectric layer 108 of this embodiment is a transparent dielectric layer, for instance, and the dielectric layer 108 can be made of an inorganic insulating material (e.g., silicon oxide, silicon nitride, silicon oxynitride, or a stacked layer containing at least two of the aforesaid materials), an organic insulating material, or a combination thereof.

With reference to FIG. 1E and FIG. 2E, a plurality of pixel electrodes PE are formed on the dielectric layer 108, and the active device array substrate 100 is then formed. The pixel electrodes PE are located in the display area R1, and the second openings H2 corresponding to the pixel electrodes PE are filled with the corresponding pixel electrodes PE. Thereby, the pixel electrodes PE are electrically connected to the corresponding active devices T. Each of the pixel electrodes PE has a plurality of slits g, and a portion of the common electrode 106 located under the slits g is not shaded by the pixel electrodes PE.

Particularly, the common electrode 106 is electrically insulated from the pixel electrodes PE by the dielectric layer 108. An electric field is generated between the pixel electrodes PE and the common electrode 106 because of the slits g that expose the common electrode 106.

It should be mentioned that one dielectric layer 108 is sandwiched by the pixel electrodes PE and the common electrode 106 in this embodiment. As such, in a direction perpendicular to the surface of the substrate 102, the distance between the pixel electrodes PE and the common electrode 106 is substantially equal to the thickness of the dielectric layer 108. Consequently, the electric field between the pixel electrodes PE and the common electrode 106 can be significantly increased.

In addition, according to this embodiment, a portion of the data lines DL can be overlapped with a portion of the pixel electrodes PE, so as to increase the aperture ratio of the pixel array substrate 100. To be more specific, the passivation layer 104, the common electrode 106, and the dielectric layer 108 are sandwiched by a portion of the data lines DL and a portion of the pixel electrodes PE, such that the distance between the data lines DL and the pixel electrodes PE is rather large. Thereby, the capacitive coupling effect occurring between the data lines DL and the pixel electrodes PE is not significant, and thus a portion of the data lines DL can be overlapped with a portion of the pixel electrodes PE to increase the aperture ratio of the pixel array substrate 100.

### Second Embodiment

The pixel array substrate 100A of this embodiment is similar to the pixel array substrate 100 of the first embodiment. Therefore, the difference therebetween is described hereinafter, while the similarity therebetween is omitted.

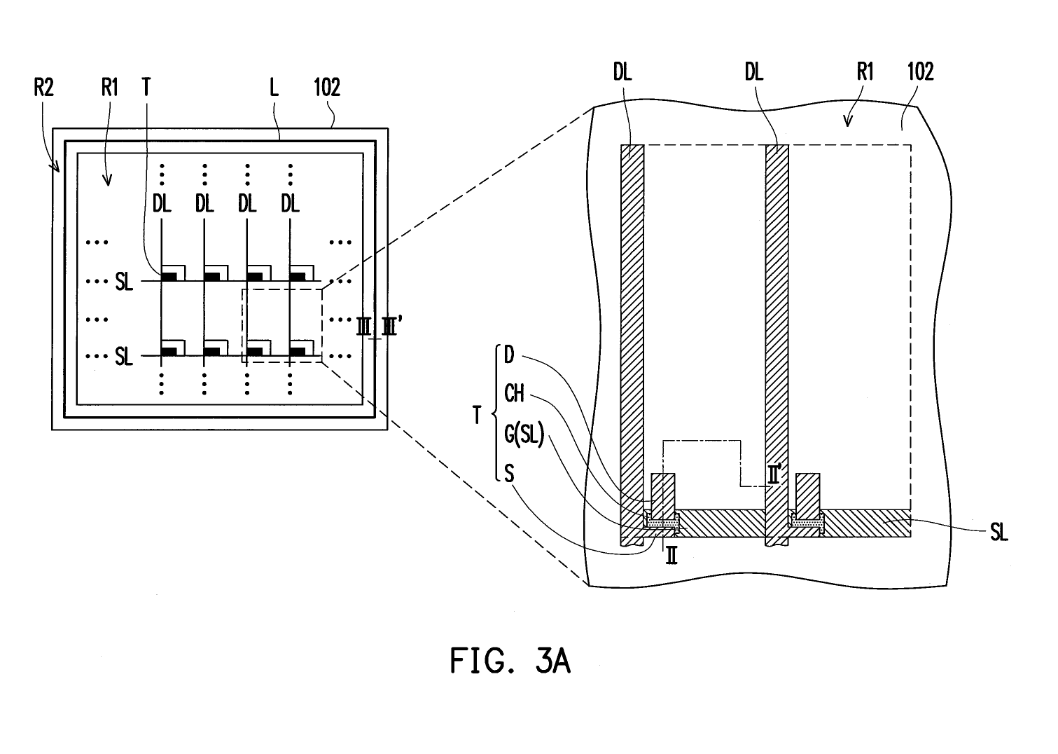

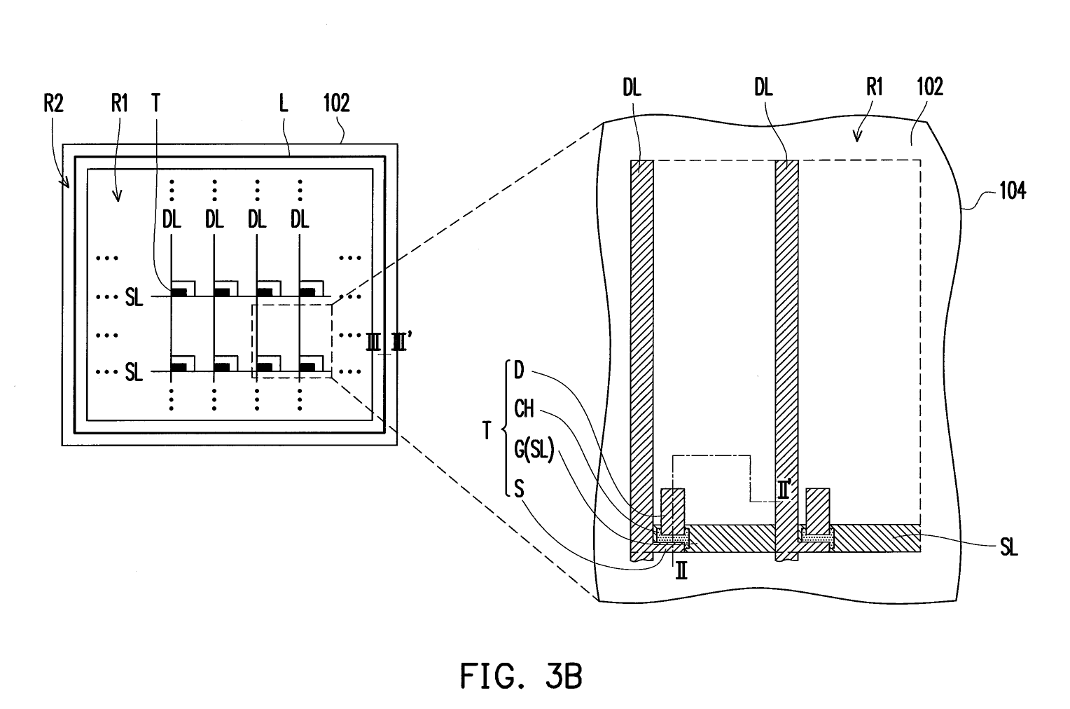

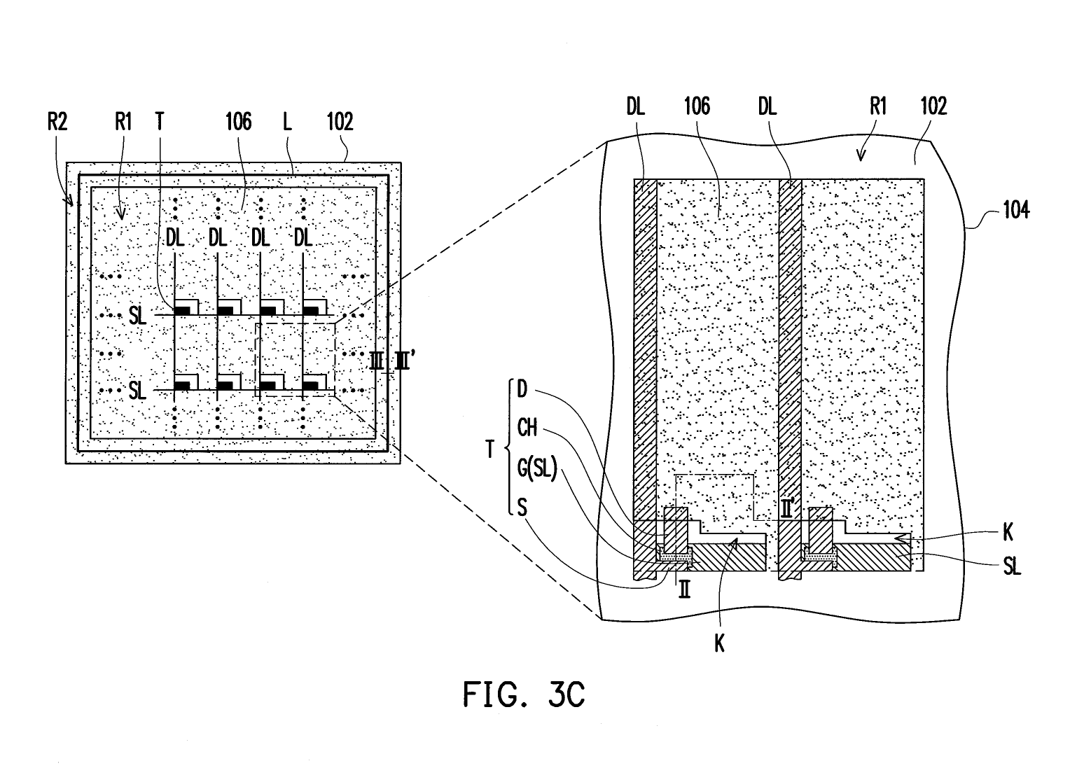

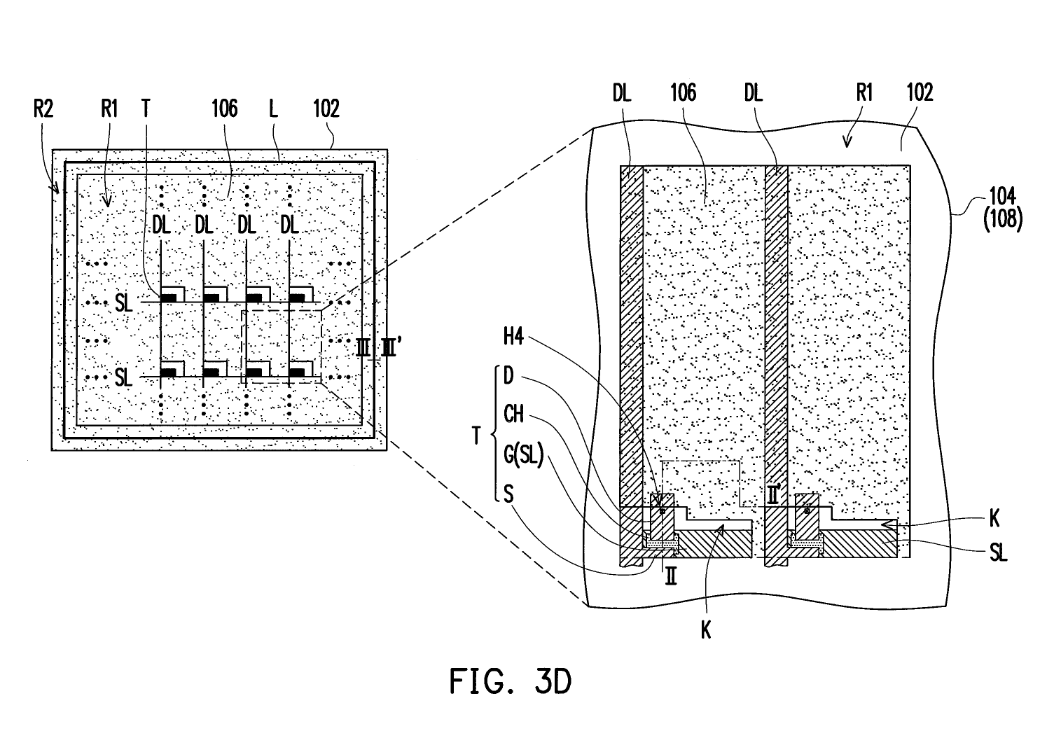

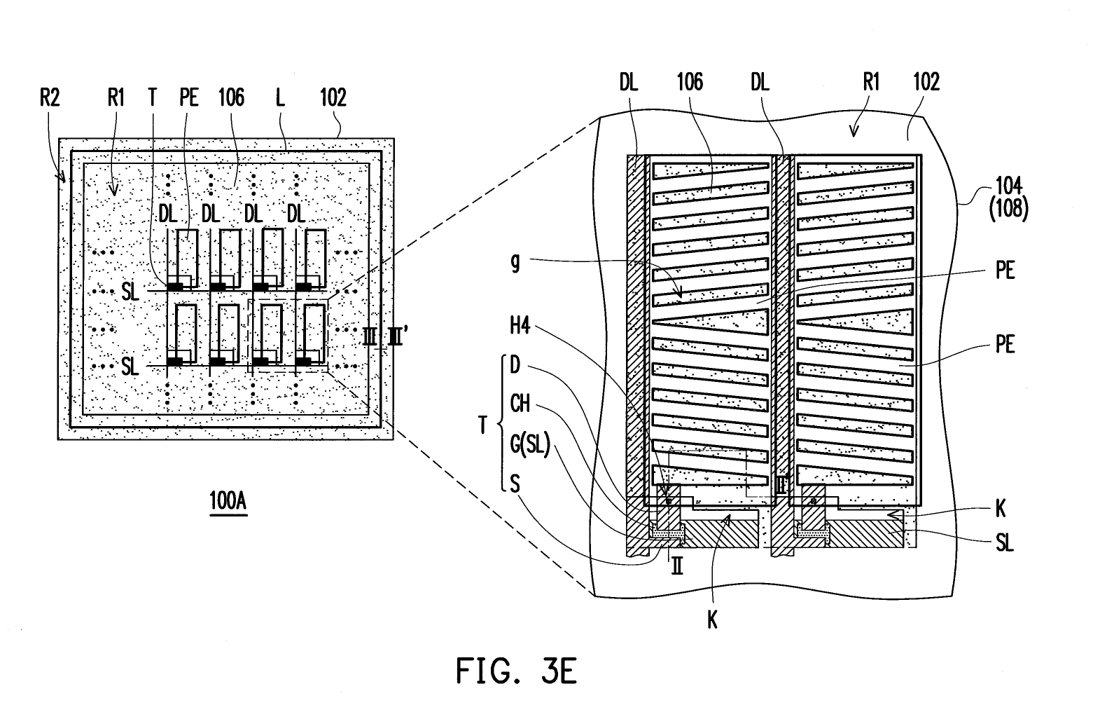

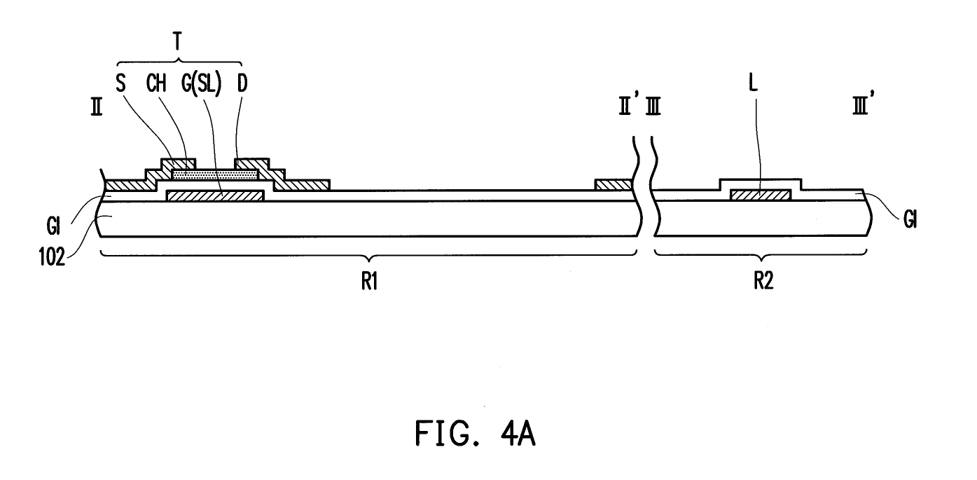

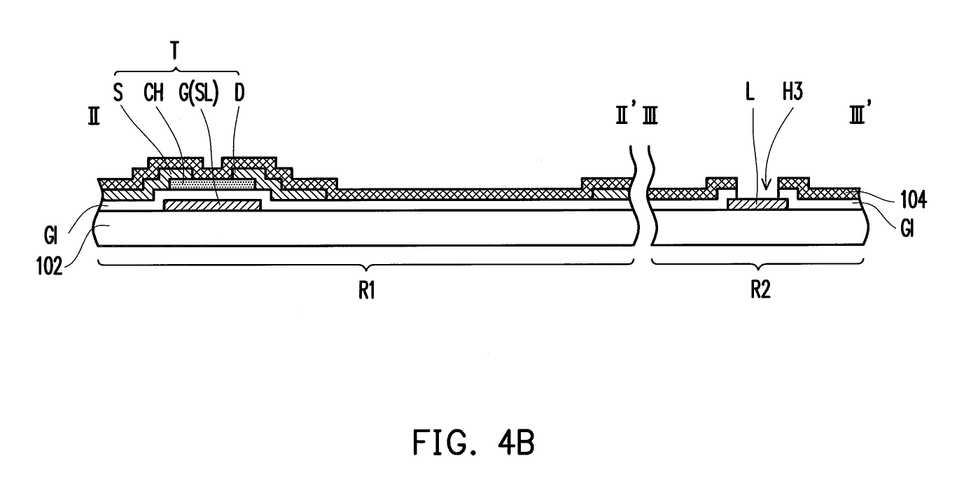

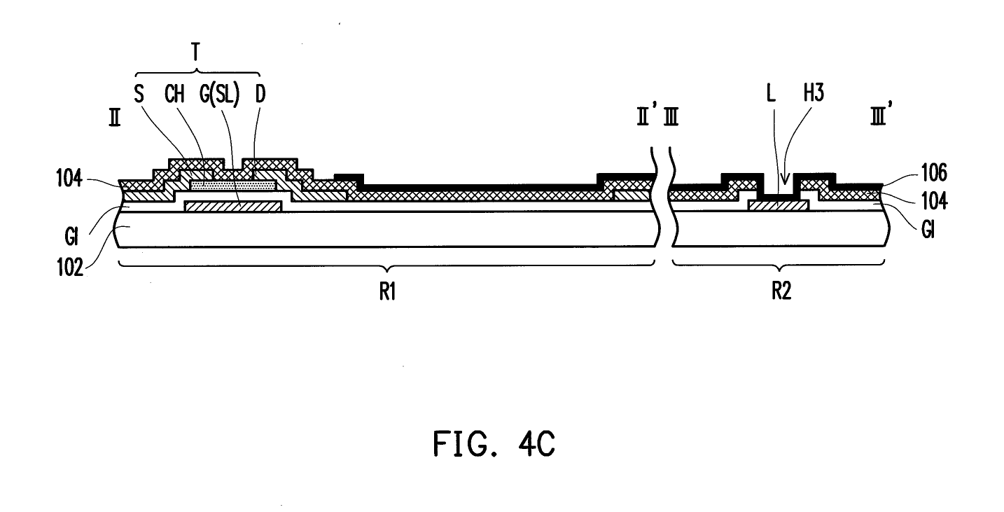

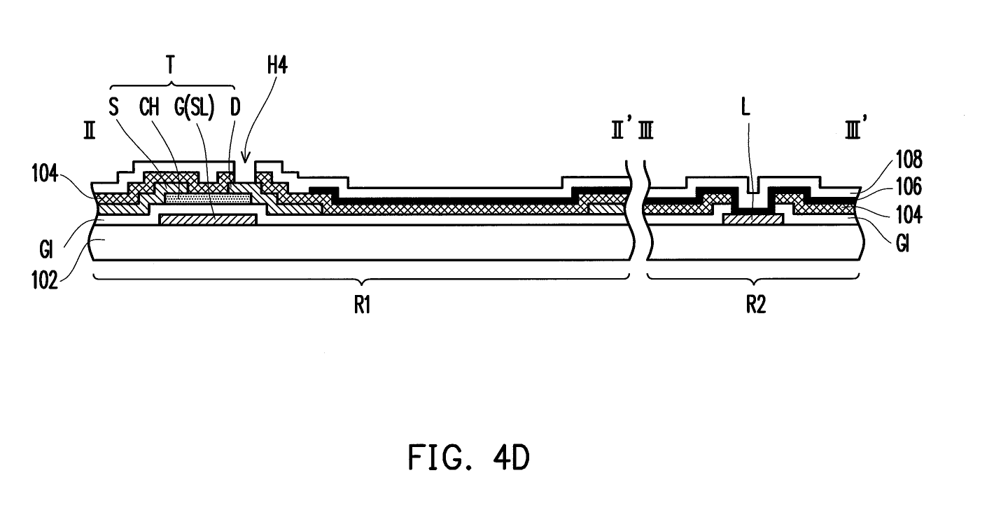

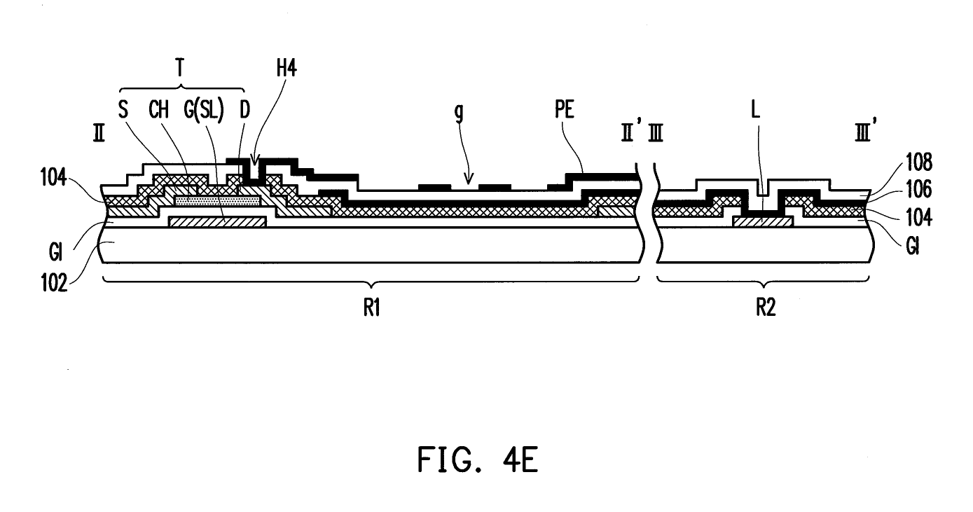

FIG. 3A to FIG. 3E are schematic top views illustrating a process of fabricating a pixel array substrate according to another embodiment of the invention. FIG. 4A to FIG. 4E are schematic cross-sectional views taken along a sectional line II-II′ and a sectional line III-III′ of FIG. 3A to FIG. 3E and illustrating the process of fabricating the pixel array substrate.

With reference to FIG. 3A and FIG. 4A, a substrate 102 is provided. The substrate 102 has a display area R1 and a peripheral area R2. A plurality of scan lines SL are formed on the display area R1 of the substrate 102, and a peripheral circuit L is formed on the peripheral area R2 of the substrate 102. In this embodiment, the peripheral area R2 is a ring-shaped area that surrounds the display area R1 and is connected to the display area R1. The peripheral circuit L is a ring-shaped circuit, for instance, and the ring-shaped circuit surrounds the display area R1 of the substrate 102. The peripheral circuit L and the scan lines SL can be made of similar materials, and thus no further descriptions are provided herein.

An insulating layer GI is formed on the display area R1 and the peripheral area R2 of the substrate 102, and the insulating layer GI covers the scan lines SL and the peripheral circuit L. Channel layers CH are formed on a portion of the scan lines SL, and the portion of the scan lines SL can serve as gates G. Data lines DL are formed on the channel layers CH and the insulating layer GI. Here, a portion of the data lines DL that is overlapped with the channel layers CH serves as sources S. Meanwhile, drains D are formed on the channel layers CH, so as to form active devices T. Namely, the active devices T are electrically connected to the scan lines SL and the data lines DL. The active devices T described above are bottom-gate TFTs, for instance, which should not be construed as a limitation to the invention. In other embodiments, the active devices T can also be top-gate TFTs, multi-gate TFTs, and so on.

In this embodiment, the data lines DL and the scan lines SL are intersected. That is to say, the extension direction of the data lines DL is not parallel to the extension direction of the scan lines SL. According to this embodiment, the extension direction of the data lines DL is perpendicular to the extension direction of the scan lines SL, for instance.

With reference to FIG. 3B and FIG. 4B, a passivation layer 104 is formed on the substrate 102, and the passivation layer 104 covers the active devices T, the scan lines SL, the data lines DL, and the peripheral circuit L. A third opening H3 is formed in the passivation layer 104 that is located above the peripheral circuit L, and the third opening H3 exposes the peripheral circuit L. It should be mentioned that the third opening H3 penetrates the passivation layer 104 and the insulating layer GI, for instance, such that the third opening H3 exposes the peripheral circuit L.

As indicated in FIG. 3C and FIG. 4C, a common electrode 106 is formed on the passivation layer 104. The common electrode 106 extends from the display area R1 to the peripheral area R2. In other words, the common electrode 106 is located in both the peripheral area R2 and the display area R1. Additionally, the third opening H3 is filled with a portion of the common electrode 106 that is located in the peripheral area R2, such that the common electrode 106 is electrically connected to the peripheral circuit L.

With reference to FIG. 3D and FIG. 4D, a dielectric layer 108 is formed on the substrate 102, and the dielectric layer 108 covers the common electrode 106. A plurality of fourth openings H4 are formed in the passivation layer 104 and the dielectric layer 108 located above the active devices T, and the fourth openings H4 expose the drains D of the active devices T.

With reference to FIG. 3E and FIG. 4E, a plurality of pixel electrodes PE are formed on the dielectric layer 108. The fourth openings H4 corresponding to the pixel electrodes PE are filled with the corresponding pixel electrodes PE, such that the pixel electrodes PE are electrically connected to the drains D of the corresponding active devices T. Each of the pixel electrodes PE has a plurality of slits g, and a portion of the common electrode 106 located under the slits g is not shaded by the pixel electrodes PE. As a result, the pixel array substrate 100A of this embodiment is formed.

Note that the pixel array substrate 100A of this embodiment does not include the common electrode lines CL configured in the display area R1. Generally, the common electrode lines CL are made of an opaque conductive material, e.g., metal, so as to ensure that the signal transmission quality is favorable. Consequently, the pixel array substrate 100A of this embodiment not only has the advantages of the pixel array substrate 100 described in the first embodiment but also has the increased aperture ratio.

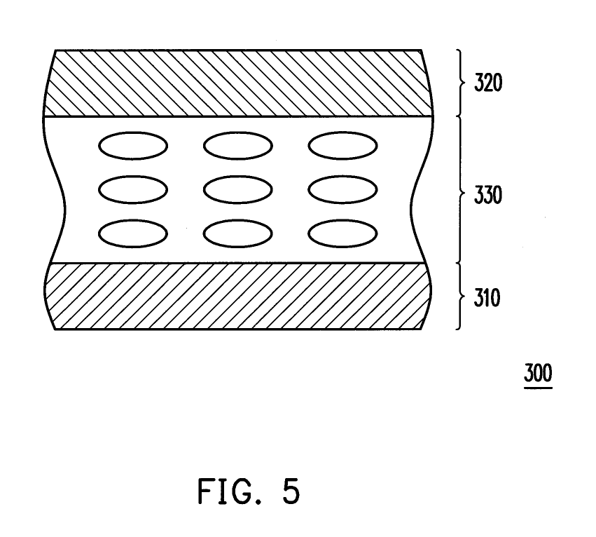

FIG. 5 illustrates a display panel according to an embodiment of the invention. With reference to FIG. 5, the display panel 300 includes a pixel array substrate 310, an opposite substrate 320, and a display medium layer 330. The pixel array substrate 310 is opposite to the opposite substrate 320, and the display medium layer 330 is configured between the pixel array substrate 310 and the opposite substrate 320. The display medium layer 330 is a liquid crystal layer, for instance. Specifically, the pixel array substrate 310 is selected from the aforesaid pixel array substrate 100 described in the first embodiment or the aforesaid pixel array substrate 100A described in the second embodiment. According to the previous embodiments, the electric field generated between the pixel electrodes PE and the common electrode 106 in the pixel array substrate 100 and in the pixel array substrate 100A is significant. Hence, the display medium of the display medium layer 330 can be efficiently driven, and thereby the display luminance of the display panel 300 can be effectively improved. Moreover, the pixel array substrates 100 and 100A are both characterized by the favorable aperture ratio, and therefore the display panel 300 can have favorable display luminance.

In light of the foregoing, one dielectric layer is sandwiched by the pixel electrodes and the common electrode in a direction perpendicular to the surface of the substrate in the pixel array substrate described in the embodiments of the invention. By contrast, a plurality of insulating layers are sandwiched by the pixel electrodes and the common electrode in the conventional pixel array substrate. Namely, in the pixel array substrate described in the embodiments of the invention, the distance between the pixel electrodes and the common electrode is short, such that the electric field between the pixel electrodes and the common electrode is significant. As such, the display medium in the display panel that has the pixel array substrate described in the embodiments of the invention can be effectively driven by the display panel, and thereby the driving voltage of the display panel can be effectively reduced.

Moreover, in the pixel array substrate described in the embodiments of the invention, the common electrode has a plurality of openings, and each of the openings exposes one of the active devices and one of the scan lines electrically connected to the active device. Thereby, the parasitic capacitance between the common electrode and the scan lines and between the common electrode and the active devices can be effectively reduced, and issues of signal delay and large driving load can be resolved.

On the other hand, a plurality of insulating layers and a common electrode layer are sandwiched by the pixel electrodes and the data lines in the pixel array substrate of the invention, such that the capacitive coupling effect between the data lines and the pixel electrodes is insignificant. As a result, the pixel electrodes and the data lines can be partially overlapped, which leads to an increase in the aperture ratio of the pixel array substrate.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A pixel array substrate comprising:
a substrate having a display area and a peripheral area, the peripheral area substantially connected to the display area;
a plurality of scan lines and a plurality of data lines, configured in the display area of the substrate, the scan lines and the data lines intersected;
a plurality of active devices configured in the display area of the substrate and electrically connected to the scan lines and the data lines;
a passivation layer covering the active devices;
a common electrode configured on the passivation layer and located at least in the display area;
a dielectric layer covering the common electrode; and
a plurality of pixel electrodes configured on the dielectric layer, each of the pixel electrodes electrically connected to one of the active devices and having a plurality of slits, wherein a portion of the common electrode located under the slits is not shaded by the pixel electrodes.

2. The pixel array substrate as claimed in claim 1, further comprising a plurality of common electrode lines, the common electrode lines and the data lines intersected, an extension direction of the common electrode lines substantially parallel to an extension direction of the scan lines, and the common electrode electrically connected to the common electrode lines.

3. The pixel array substrate as claimed in claim 1, wherein the common electrode has a plurality of openings, and each of the openings exposes one of the active devices and one of the scan lines electrically connected to the one of the active devices.

4. The pixel array substrate as claimed in claim 1, wherein a portion of the data lines and a portion of the pixel electrodes are overlapped.

5. The pixel array substrate as claimed in claim 1, further comprising a peripheral circuit configured in the peripheral area, the common electrode further extending to the peripheral area to electrically connect the peripheral circuit.

6. The pixel array substrate as claimed in claim 5, wherein the peripheral circuit is a ring-shaped circuit surrounding the display area of the substrate.

7. A display panel comprising:
the pixel array substrate as claimed in claim 1;
an opposite substrate opposite to the pixel array substrate; and
a display medium layer configured between the pixel array substrate and the opposite substrate.

8. A method of fabricating a pixel array substrate, comprising:
providing a substrate, the substrate having a display area and a peripheral area, the peripheral area substantially connected to the display area on which a plurality of scan lines, a plurality of data lines, a plurality of active devices, and a plurality of common electrode lines are formed, wherein the scan lines and the data lines are intersected, each of the active devices is electrically connected to a corresponding one of the scan lines and a corresponding one of the data lines, and the common electrode lines and the data lines are intersected;
forming a passivation layer on the substrate, the passivation layer covering the active devices, the common electrode lines, the scan lines, and the data lines;
forming a plurality of first openings in the passivation layer located above the common electrode lines, the first openings exposing the common electrode lines;
forming a common electrode on the passivation layer, the common electrode located in the display area and filling the first openings, such that the common electrode is electrically connected to the common electrode lines;
forming a dielectric layer on the substrate, the dielectric layer covering the common electrode;
forming a plurality of second openings in the passivation layer and the dielectric layer that are located above the active devices, the second openings exposing the active devices;
forming a plurality of pixel electrodes on the dielectric layer, the pixel electrodes located in the display area of the substrate, the second openings corresponding to the pixel electrodes filled with the corresponding pixel electrodes, such that the pixel electrodes are electrically connected to the active devices corresponding thereto, wherein each of the pixel electrodes has a plurality of slits, and a portion of the common electrode located under the slits is not shaded by the pixel electrodes.

9. A method of fabricating a pixel array substrate, comprising:
providing a substrate, the substrate having a display area and a peripheral area, the peripheral area substantially connected to the display area on which a plurality of scan lines, a plurality of data lines, and a plurality of active devices are formed, wherein the scan lines and the data lines are intersected, each of the active devices is electrically connected to a corresponding one of the scan lines and a corresponding one of the data lines, and the peripheral area of the substrate has a peripheral circuit thereon;
forming a passivation layer on the substrate, the passivation layer covering the active devices, the scan lines, the data lines, and the peripheral circuit;
forming a third opening in the passivation layer located above the peripheral circuit, the third opening exposing the peripheral circuit;
forming a common electrode on the passivation layer, the common electrode located in both the peripheral area and the display area, the third opening filled with a portion of the common electrode located in the peripheral area, such that the common electrode is electrically connected to the peripheral circuit;
forming a dielectric layer on the substrate, the dielectric layer covering the common electrode;
forming a plurality of fourth openings in the passivation layer and the dielectric layer located above the active devices, the fourth openings exposing the active devices;
forming a plurality of pixel electrodes on the dielectric layer, the fourth openings corresponding to the pixel electrodes filled with the corresponding pixel electrodes, such that the pixel electrodes are electrically connected to the active devices corresponding thereto, wherein each of the pixel electrodes has a plurality of slits, and a portion of the common electrode located under the slits is not shaded by the pixel electrodes.
